(19) United States
(12) Patent Application Publication
(10) Pub. No.: US 2017/0040602 A1
(43) Pub. Date: Feb. 9, 2017

(54) NEGATIVE ELECTRODE FOR SECONDARY BATTERY AND MANUFACTURING METHOD OF THE SAME

(71) Applicant: OCI COMPANY LTD., Seoul (KR)

(72) Inventors: Jeong-Hyun HA, Seongnam-si (KR); Yo-Seop KIM, Seongnam-si (KR); Eun-Hye JEONG, Seongnam-si (KR); Jun-Eun LEE, Seongnam-si (KR)

(21) Appl. No.: 15/229,999

(22) Filed: Aug. 5, 2016

(30) Foreign Application Priority Data
Aug. 7, 2015 (KR) 10-2015-0111359

(51) Int. Cl. H01M 4/36; H01M 4/60; H01M 10/0525; H01M 4/587

(52) U.S. Cl. CPC H01M 4/366; H01M 4/587; H01M 4/602; H01M 10/0525; H01M 2004/027

(57) ABSTRACT

The present invention relates to a negative electrode for a secondary battery and a method for manufacturing the negative electrode, and more particularly, to a negative electrode for a secondary battery which exhibits excellent charge/discharge characteristics and lifespan characteristics by including a carbon-silicon composite and graphite at a predetermined particle size ratio.

### BACKGROUND

1. Technical Field

The present invention relates to a negative electrode for a secondary battery and a method for manufacturing the negative electrode, and more particularly, to a negative electrode for a secondary battery that exhibits excellent charge/discharge characteristics and lifespan characteristics by including a carbon-silicon composite and graphite at a predetermined particle size ratio.

2. Description of the Related Art

Lithium secondary batteries have high energy density, high voltage, and high capacity characteristics, compared to those of other secondary batteries, and thus have been widely used as a power source of various devices.

Particularly, in order to use a lithium secondary battery in IT devices or as a vehicle battery, a negative electrode active material of a lithium secondary battery that may realize a high capacity is needed.

In general, a negative electrode active material of a lithium secondary battery mainly includes a carbonaceous material such as graphite. A theoretical capacity density of 372 mAh/g, but the actual capacity density is reduced to about 310 to 330 mAh/g due to a capacity loss, and thus demands for a lithium secondary battery having a high energy density have increased.

Also, graphite has a flake-like shape, which may be easily pressed when used as a negative electrode active material and thus exhibits a high electrode density. However, a porosity between the active materials decreases, and thus impregnating graphite in an electrolyte solution is not easy.

According to the demands, studies have been conducted on a metal or an alloy to be used as a negative electrode active material of a lithium secondary battery having a high capacity, and particularly, silicon has been spot-lighted as the electrode active material.

For example, pure silicon has a high theoretical capacity of about 4,200 mAh/g.

However, a silicon material has deteriorated cycle characteristics compared to those of the carbonaceous material, and thus commercialization of the silicon material is limited.

It is because when an inorganic particle such as silicon is used as a material for lithium intercalation and deintercalation as in a negative electrode active material, conductivity between the active material may deteriorate due to a volume change during a charge/discharge process, or the negative electrode active material is detached from a negative electrode current collector which causes electrical contact inferiority.

That is, when an inorganic particle such as silicon included in the negative electrode active material intercalates lithium by the charge process, a volume of the inorganic particle increases up to about 300 to about 400% of the original volume, and when lithium is intercalated by the discharge process, a volume of the inorganic particle may be reduced back.

As the charge/discharge cycle are repeated, electrical insulation may be formed due to an empty space between the inorganic particle and the negative electrode active material, and thus lifespan of the secondary battery may deteriorate, which becomes a problem in the use of the secondary battery.

In order to solve the problem, it is essential to evenly disperse silicon. Accordingly, a variety of attempts have been made including regulating the size of silicon particles, preparing a powder including silicon, and forming pores.

However, when silicon is included as a negative electrode active material, an electrode density decreases due to a high specific surface area compared to that of graphite, and thus a capacity of the secondary battery decreases with respect to a unit volume.

In view of the above, what is required is a negative electrode that contains silicon having high capacity and still achieves high electrode density and high electrolyte solution impregnating property so that lithium ions are easily diffused in the negative electrode.

### SUMMARY

It is an aspect of the present invention to provide a negative electrode for a secondary battery which has an improved battery capacity and an excellent electrolyte solution impregnating property by including a carbon-silicon composite and graphite and, at the same time, controlling a ratio of particle sizes of the carbon-silicon composite and graphite, wherein the carbon-silicon composite includes a Si-block copolymer core-shell particle in a carbon material to improve a charge capacity and lifespan characteristics of the secondary battery.

The present invention is not limited to the above aspect and other aspects of the present invention will be clearly understood by those skilled in the art from the following description.

In accordance with one aspect of the present invention, a negative electrode for a secondary battery includes a negative electrode active material that includes a carbon-silicon composite having a Si-block copolymer core-shell particle in a carbonaceous material; and graphite, wherein the negative electrode comprises a plurality of pores therein, and when a 50% accumulated weight particle size distribution diameter in particle distribution in the negative electrode is D50, D50 of the carbon-silicon composite is D_{Si—C}, and D50 of graphite is D_{G}, D_{Si—C} and D_{G} satisfy 1.0≦D_{G}/D_{Si—C}≦1.8.

In accordance with one aspect of the present invention, a method for manufacturing a negative electrode for a secondary battery includes (a) mixing a slurry solution including Si-block copolymer core-shall particles and a carbonaceous raw material to prepare a mixture; (b) performing heat-treatment on the mixture; (c) carbonizing and pulverizing the heat-treated mixture to prepare a carbon-silicon composite; (d) mixing the carbon-silicon composite and graphite to prepare a negative electrode active material; and (e) coating a current collector with a mixture of the negative electrode active material, a conducting agent, a binder, and a thickener, wherein the carbonizing and pulverizing are repeated at least twice, and when a 50% accumulated weight particle size distribution diameter in particle distribution in the negative electrode is D50, D50 of the carbon-silicon composite is D_{Si—C}, and D50 of graphite is D_{G}, D_{Si—C} and D_{G} satisfy 1.0≦D_{G}/D_{Si—C}≦1.8.

Therefore, a negative electrode for a secondary battery, according to the present invention, includes a carbon-silicon composite and graphite at a ratio of D_{Si—C} and D_{G} that satisfy 1.0≦D_{G}/D_{Si—C}≦1.8, and, as the negative electrode has appropriate levels of an electrode porosity and a fine porosity, the negative electrode exhibits an electrode density at the level of that of graphite. Therefore, the negative electrode may have an excellent charge/discharge capacity and an electrolyte solution impregnating property at the same time, and thus the secondary battery including the negative electrode may exhibit excellent battery lifespan characteristics.

### BRIEF DESCRIPTION OF DRAWINGS

FIG. 1 is a scanning electron microscope (SEM) image of a carbon-silicon composite prepared in Example 1 of the present invention, and the image was taken by using a scanning electron microscope.

FIG. 2 shows a graph that illustrates distribution of pore diameters of negative electrodes prepared in Example 1 and Comparative Example 3 of the present invention.

FIG. 3 is an SEM image of a negative electrode prepared in Example 1 that is not roll-pressed.

FIG. 4 is an SEM image of a negative electrode prepared in Example 1 that is roll-pressed.

FIG. 5 is an SEM image of a negative electrode prepared in Comparative Example 1 that is not roll-pressed.

FIG. 6 is an SEM image of a negative electrode prepared in Comparative Example 1 that is roll-pressed.

FIG. 7 is an SEM image of a negative electrode prepared in Comparative Example 2 that is not roll-pressed.

FIG. 8 is an SEM image of a negative electrode prepared in Comparative Example 2 that is roll-pressed.

FIG. 9 shows a graph that illustrates electrolyte solution impregnation time and electrode densities of the negative electrodes prepared in Example 1 and Comparative Examples 1 and 2.

### DETAILED DESCRIPTION

Hereinafter, embodiments of the present invention will be described in detail with reference to the accompanying drawings. It should be understood that the present invention is not limited to the following embodiments, and that the embodiments are provided for illustrative purposes only. The scope of the invention should be defined only by the accompanying claims and equivalents thereof. Like reference numerals in the drawings denote like elements.

Hereinafter, a slurry for preparing a negative electrode material for a secondary battery according to an embodiment of the present invention will be described.

When silicon is included as a conventional negative electrode active material to manufacture a battery having a high capacity, conductivity of the battery may deteriorate due to a volume change of Si during a battery charge/discharge process, and the negative electrode active material may be separated from a negative electrode current collector.

In this regard, the present invention provides Si-block copolymer core-shell particles, which include nano Si fine particles as a core and a block copolymer that forms a spherical micelle structure with the core in the center, are not agglomerated during the process of forming a carbon-silicon composite along with a carbonaceous material.

Also, in the carbon-silicon composite preparation process, carbonizing and pulverizing processes are performed at least twice under predetermined conditions, and a ratio of particle sizes of the carbon-silicon composite and graphite is controlled and applied to a negative electrode for a secondary battery.

As a result, a negative electrode for a secondary battery having excellent battery characteristics by even dispersion of silicon in the negative electrode, an electrode density at the level equivalent to that of graphite or higher, and an excellent electrolyte solution impregnating property has been developed.

The present invention may provide a negative electrode for a secondary battery that includes a negative electrode active material including a carbon-silicon composite and graphite, wherein the carbon-silicon composite has a Si-block copolymer core-shell particle in a carbonaceous material; and a plurality of pores, wherein when a 50% accumulated weight particle size distribution diameter in particle distribution in the negative electrode is D50, D50 of the carbon-silicon composite is D_{Si—C}, and D50 of graphite is D_{G}, D_{Si—C} and D_{G} satisfy 1.0≦D_{G}/D_{Si—C}≦1.8.

The negative electrode for a secondary battery according to the present invention is manufactured by using unique physical characteristics of each of the carbon-silicon composite and graphite, and when a particle size ratio of the carbon-silicon composite and graphite satisfies 1.0≦D_{G}/D_{Si—C}≦1.8, the negative electrode including the carbon-silicon composite and graphite may have appropriate levels of an electrode porosity and a fine porosity, and thus an electrode density of the negative electrode may be at the level equivalent to that of graphite, which may result in the secondary battery to have excellent battery lifespan characteristics since an electrolyte solution impregnating property as well as a charge/discharge capacity is excellent.

Graphite used in the present invention is a spherical graphite, in which several graphite layers overlap and form a sphere as flake-like graphite undergoes a spherization process, and thus the graphite has a plurality of pores.

Such porous space formed inside the spherical graphite benefits when the graphite is pressed. Accordingly, when the graphite is roll-pressed to be used in an electrode, high electrode density can be achieved.

On the other hand, since a main backbone of the carbon-silicon composite is carbonized pitch, the carbon-silicon composite may not be easily compressed, compared to graphite, and thus when the carbon-silicon composite is used in an electrode, the carbon-silicon composite may maintain a porosity inside the electrode not to be lowered.

When an electrode density increases as an electrode is compressed, more amount of energy may be stored in a limited space, and thus commercial battery manufacturers generally aim to manufacture an electrode having a high electrode density.

However, when the electrode density is high, a porosity in the electrode decreases, and thus a space necessary for electrolyte solution penetration and lithium ion diffusion may be insufficient, which may result in deterioration of battery performance.

Therefore, since increasing the electrode density while maintaining an appropriate level of porosity is important, the present invention has resolved the problems described above by manufacturing an active material, which may secure a porosity and an electrolyte solution impregnating property and realize a high electrode density through graphite.

In order to satisfy the porosity and the electrode density at the same time, an equal pressure on the carbon-silicon composite and graphite particles is important, which is related to a particle size ratio of the two particles.

In some embodiment, when a particle size ratio (D_{G}/D_{Si—C}) of the carbon-silicon composite and graphite is in a range of about 1.0 to about 1.8, active materials of the carbon-silicon composite and graphite that are pressed at different degrees of pressure may receive evenly dispersed pressure.

In some embodiment, when D_{G}/D_{Si—C} is lower than 1.0, since a particle size of the carbon-silicon composite is larger than a particle size of graphite, large pores are formed within the carbon-silicon composite, and graphite may be inserted in the pores, where the carbon-silicon composite mainly receiving the pressure during the pressing process does not easily shrink, and thus an electrode density decreases.

Also, when D_{G}/D_{Si—C} is higher than 1.8, since a difference between sizes of the carbon-silicon composite and graphite may be too large, a fine porosity increases as the relatively small carbon-silicon composite particle is inserted into spaces between the relatively large graphite particles, and an electrode density of a negative electrode manufactured by using the carbon-silicon composite and graphite as a negative electrode active material may also decrease.

That is, when a negative electrode active material is prepared by using the carbon-silicon composite only, an electrode density may be too low, and thus graphite is mixed to the carbon-silicon composite to increase the electrode density. In this regard, when a ratio of particle sizes of the carbon-silicon composite and graphite is within this range, the negative electrode active material may exhibit excellent impregnating property as pores in the electrode may be appropriately secured while realizing a high electrode density.

In some embodiments, D50 of the carbon-silicon composite may satisfy 3 μm≦D_{Si—C}≦12 μm, and D50 of the graphite may satisfy 8 μm≦D_{G}≦20 μm.

A secondary battery having improved charge/discharge characteristics and an electrolyte solution impregnating property may be provided by including the carbon-silicon composite and graphite having the particles sizes within these ranges which satisfy 1.0≦D_{G}/D_{Si—C}≦1.8.

The negative electrode may provide a negative electrode for a secondary battery having an electrode porosity in a range of about 25% to about 45%.

The electrode porosity is obtained from an electrode density and a tap density using Equation (1), which is a percent calculated by including all pores inside and outside the particle in the negative electrode.

$$Electrode porosity = \frac{{D}_{R} - {D}_{T}}{1 + {D}_{R} - {D}_{T}} \\ ( {D}_{R} \text{:} electrode density , {D}_{T} \text{:} tap density ) . \qquad Equation ( 1 )$$

When only conventional graphite is used as a negative electrode active material, a high electrode density may be realized during the pressing process due to a soft physical property of the graphite, but the graphite may be pressed to a degree that there is no space for an electrolyte solution to pervade in the graphite.

Also, when only the carbon-silicon composite is used, a compressibility is poor even when the pressing is strongly performed, and thus increasing an electrode density is limited.

In this regard, a negative electrode for a secondary battery according to the present invention includes the carbon-silicon composite and graphite as a negative electrode active material while controlling shapes and sizes of the silicon composite and graphite, and thus the problems described above may be resolved.

That is, since the negative electrode active material according to the present invention includes a ratio of particle sizes of the carbon-silicon composite and graphite within the predetermined range, an electrode porosity within the range above may be secured which may increase an impregnating property of an electrolyte solution, and thus lithium ions may be easily diffused in the negative electrode, which may result in improving the total lifespan characteristics of the battery.

In some embodiments, when the electrode porosity is lower than 25%, the negative electrode active material in the negative electrode is tightly arranged, which may unease penetration of an electrolyte solution, and thus resistance increases during lithium ion diffusion. In this regard, battery performance may deteriorate.

Also, when the electrode porosity is higher than 45%, an electrode density decreases below the limit of a common level, and thus a charge/discharge capacity of the battery may decrease.

Therefore, the negative electrode for a secondary battery according to the present invention including the carbon-silicon composite and graphite may have both a high charge/discharge capacity and lifespan characteristics at the same time by realizing an appropriate porosity.

Also, a fine porosity in the electrode for a secondary battery according to the present invention may be in a range of about 30% to about 50%.

As used herein, the term “fine pores” denotes pores having diameter of less than 100 nm in the negative electrode, and the term “fine porosity” denotes a ratio of pores having diameter of less than 100 nm among all the pores formed in the negative electrode.

The fine porosity is a concept different from an electrode porosity, where pores of the electrode porosity include pores inside the particle and pores outside the particle, and the fine pores of the fine porosity refer to pores having diameter of less than 100 nm among outside the particle.

When the fine porosity is lower than 30%, an electrolyte solution impregnating property may be decreased, because a ratio of pores inside the particle may be high even an electrode porosity in the negative electrode is high. When the fine porosity is higher than 50%, charge/discharge efficiency may be decreased even when the electrode porosity is maintained at an appropriate level, because a ratio of the fine pores among the pores outside the particle in the negative electrode is too high.

Particularly, the fine pores are related to particle sizes of the carbon-silicon composite and graphite, and when a ratio (D_{G}/D_{Si—C}) of particle sizes of the carbon-silicon composite and graphite is higher than 1.8, as described above, the fine porosity may significantly increase. Thus, when the ratio of particles sizes is maintained 1.8 or lower to control the fine porosity within the range above, a secondary battery may have an electrode density at a level similar to that of graphite.

A tap density (D_{T}) of the negative electrode active material may be in a range of about 1.0 g/cc to about 1.2 g/cc.

As used herein, the term “tap density” is a weight per volume of a powder formed of particles and refers to a density after filling pores between the particles by constantly tapping or vibrating the negative electrode active material.

Factors that may influence the tap density may include a particle size distribution diagram, a moisture amount, a particle shape, and cohesiveness, and a fluidity and a compressibility of a material may be predicted using the tap density.

In the present invention, the tap density may be realized by controlling a particle size ratio and particle shape of the carbon-silicon composite and graphite.

When the tap density is lower than 1.0 g/cc, an amount of the negative electrode active material per volume of the secondary battery relatively decreases, and thus a capacity per volume of the secondary battery may decrease.

When the tap density is higher than 1.2 g/cc, the compression may not be well performed on the material, which may detach the material from a current collector, and thus process-related problems including increased time for injecting an electrolyte solution and difficulty in performing the process may occur, and high-speed charge/discharge characteristics may deteriorate.

When the tap density is in a range of about 1.0 g/cc to about 1.2 g/cc, a large amount of the negative electrode active material may be secured in the negative electrode compared to that of a conventional battery having the same volume, and the electrolyte solution may evenly penetrate into the carbon-silicon composite and graphite.

Also, an electrode density (D_{R}) of the negative electrode may be in a range of about 1.35 g/cc to about 1.85 g/cc.

An electrode density of electrodes of a secondary battery may be obtained by coating and drying the negative electrode active material on electrode substrates and then pressing the electrodes at an appropriate pressure.

The electrode density is related to various battery characteristics including an energy density of a battery and an electric conductivity and an ion conductivity of an electrode.

When the electrode density is lower than 1.35 g/cc, electrode capacity may not be sufficient. When the electrode density is higher than 1.85 g/cc, an electrode porosity is significantly lowered, and thus a reaction of lithium ions in the electrolyte solution may be difficult.

Therefore, when the electrode for a secondary battery according to the present invention has an electrode density in a range of about 1.35 g/cc to about 1.85 g/cc, a high capacity, excellent lifespan characteristics, and charge/discharge characteristics may be realized.

In the negative electrode for a secondary battery according to the present invention, the Si-block copolymer core-shell particle of the carbon-silicon composite may have a Si core; and a block copolymer shell including a block having a high affinity to Si and a block having a low affinity to Si, wherein the block copolymer shell may form a spherical micelle structure with the Si core in the center.

The Si-block copolymer core-shell particle has a structure in which a block copolymer sheel coated on a Si core wherein the block copolymer shell consisting of a block having a high affinity and a block having a low affinity to Si on a surface of the Si core. Furthermore, the block copolymer shell forms a spherical micelle structure wherein the block having a high affinity to Si on the surface of the Si core faces the surface of the Si core by the van der Waals force and the block having a low affinity to Si faces an outside of the micelle due to the van der Waals force.

A weight ratio of the Si core and the block copolymer shell may be, preferably, in a range of about 2:1 to about 1000:1, and a weight ratio of the Si core and the block copolymer shell may be, more preferably, in a range of about 4:1 to about 20:1, but the weight ratios are not limited thereto.

When a weight ratio of the Si core and the block copolymer shell is lower than 2:1, an amount of the Si core substantially alloyable with lithium decreases in the negative electrode active material, and thus a capacity of the negative electrode active material may decrease, and an efficiency of a lithium secondary battery may decrease.

When a weight ratio of the Si core and the block copolymer shell is higher than 1000:1, an amount of the block copolymer shell may decrease, which may deteriorate dispersibility and stability thereof in a slurry solution, and thus the block copolymer shell of core-shell carbonized particles in the negative electrode active material may not normally perform a buffer function.

The block having a high affinity to Si may bind toward a surface of the Si core due to the van der Waals force.

Here, the block having a high affinity to Si may be, preferably, polyacrylic acid, polyacrylate, polymethyl methacrylic acid, polymethyl methacrylate, polyacryamide, carboxymethyl cellulose, polyvinyl acetate, or polymaleic acid, but it is not limited thereto.

The block having a low affinity to Si may bind toward an outside of the Si core due to the van der Waals force.

Here, the block having a low affinity to Si may be, preferably, polystyrene, polyacrylonitrile, polyphenol, polyethylene glycol, polylauryl acrylate, or polyvinyl difluoride, but it is not limited thereto.

The block copolymer shell may be most preferably a polyacrylic acid-polystyrene block copolymer shell.

A number average molecular weight (Mn) of polyacrylic acid may be, preferably, in a range of about 100 g/mol to about 100,000 g/mol, and a number average molecular weight (Mn) of polystyrene may be, preferably, in a range of about 100 g/mol to about 100,000 g/mol, but the number average molecular weights are not limited thereto.

Also, the present invention may provide Si-block copolymer core-shell carbonized particles that are formed by carbonizing the Si-block copolymer core-shell particle. Particularly, a carbonization yield during the carbonizing process is higher from the block having a low affinity to Si than that of the block having a high affinity to Si.

That is, the block copolymer shell of the Si-block copolymer core-shell carbonized particles may form a spherical carbonized layer with the Si core in the center.

The carbonaceous material of the carbon-silicon composite included in the negative electrode for a secondary battery according to the present invention is amorphous carbon, which may be soft carbon or hard carbon.

Also, the carbonaceous material almost does not include impurities and a by-product compound and is mostly formed of carbon, and, in some embodiments, an amount of carbon in the carbonaceous material may be in a range of about 70 wt % to about 100 wt %.

A weight ratio of the carbon-silicon composite and graphite in the negative electrode may be in a range of about 50:50 to about 1:99, or, preferably, in a range of about 30:70 to about 20:80.

When the carbon-silicon composite and graphite are included at the ratio within these ranges, the negative electrode exhibited an appropriate porosity and, at the same time, a high electrode density during a roll-pressing process.

Also, the carbon-silicon composite and graphite may both have a spherical shape.

The shape of the particles influence an electrode density and a porosity, and thus when a surface of the particle is sharp or when shapes of the particles are irregular, battery characteristics of certain level or higher may not be secured.

In this regard, the negative electrode for a secondary battery includes the carbon-silicon composite and graphite all in the form of spherical particles, an energy density and an electrolyte solution impregnating property of the electrode may increase, and, as a result, a secondary battery may have improved battery characteristics.

According to another embodiment of the present invention, a method for manufacturing a negative electrode for a secondary battery includes (a) mixing a slurry solution including Si-block copolymer core-shall particles and a carbonaceous raw material to prepare a mixture; (b) performing heat-treatment on the mixture; (c) carbonizing and pulverizing the heat-treated mixture to prepare a carbon-silicon composite; (d) mixing the carbon-silicon composite and graphite to prepare a negative electrode active material; and (e) coating a current collector with a mixture of the negative electrode active material, a conducting agent, a binder, and a thickener, wherein the (c) carbonizing and pulverizing are repeated at least twice, and when a 50% accumulated weight particle size distribution diameter in particle distribution in the negative electrode is D50, D50 of the carbon-silicon composite is D_{Si—C}, and D50 of graphite is D_{G}, D_{Si—C} and D_{G} satisfy 1.0≦D_{G}/D_{Si—C}≦1.8.

In step (a), the mixture including a slurry solution including Si-block copolymer core-shall particles and a carbonaceous raw material is prepared.

When the slurry solution including the Si-block copolymer core-shell particles well dispersed therein is separately prepared before mixing the slurry solution with the carbonaceous material, Si-block copolymer core-shell carbonized particles in a nanosize may be evenly dispersed throughout the whole carbon-silicon composite, as a final product, and thus a structure of the carbon-silicon composite described above may be formed.

The slurry solution including the Si-block copolymer core-shell particles is used in the state of slurry in which the Si-block copolymer core-shell particles is evenly dispersed in a dispersion medium, and thus, unlike a silicon powder exposed to the air, the silicon particles are not exposed to the air, and thus oxidation of silicon may be suppressed.

As oxidation of silicon is suppressed, when the negative electrode active material is used for a secondary battery, a capacity of the secondary battery may increase, and thus electrical characteristics of a lithium secondary battery may further improve.

The dispersion medium that may be used in the slurry solution including the Si-block copolymer core-shell particle may be N-methyl-2-pyrrolidone (NMP), tetrahydrofuran (THF), water, ethanol, methanol, cyclohexanol, cyclohexanone, methylethylketone, acetone, ethylene glycol, octin, diethylcarbonate, or dimethylsulfoxide (DMSO).

When the dispersion medium is used, the slurry solution including the Si-block copolymer core-shell particles may be easily dispersed.

Also, since the dispersion medium may dissolve the carbonaceous material, the mixture may be prepared by dissolving the carbonaceous material in the well-dispersed slurry solution.

Since the carbonaceous material is dissolved in the silicon slurry solution, the carbonaceous material is carbonized while capturing the Si-block copolymer core-shell particles in the carbonization process thereafter, and thus a carbon-silicon composite may include the Si-block copolymer core-shell carbonized particles that are captured and dispersed in the carbonaceous material.

The carbonaceous material may be amorphous carbon which may be soft carbon or hard carbon.

In the step (b), heat-treatment is performed on the mixture, and the dispersion medium included in the mixture is distilled.

In particular, the step (b) may be performed at a temperature in a range of about 100° C. to about 200° C. and, preferably, may be performed in vacuum.

A heat-treating temperature and a heating time may vary depending on the boiling point of the dispersion medium of each type.

The dispersion medium is needed to form the structure of the carbonaceous material to capture the particles after mixing the carbonaceous material and the Si-block copolymer-core-shell particles, but the dispersion medium should not remain in the resultant of the carbon-silicon composite in terms of electrical conductivity and resistance, and thus it is preferably to distillate the dispersion medium to the maximum.

In the step (c), the heat-treated mixture is carbonized and pulverized to prepare a carbon-silicon composite, and the carbonizing and pulverizing process may be repeated at least twice alternating each other under different temperatures.

In some embodiments, the step (c) may include a primary carbonization process which includes heat-treating the mixture at a temperature in a range of about 400° C. to about 600° C. for about 1 hour to about 24 hours and then pulverizing the mixture; and a secondary carbonization process which includes heat-treating the resultant of the primary carbonization process at a temperature in a range of about 700° C. to about 1400° C. for about 1 hour to about 24 hours and then pulverizing the resultant.

Also, the primary carbonization process may be performed at a pressure in a range of about 5 bar to about 20 bar, and the secondary carbonization process may be performed at a pressure in a range of about 1 bar to about 20 bar.

In this regard, alternating the carbonizing and pulverizing is important, and when the pulverizing is performed at the last step after performing the consecutive carbonizing several times, the hardened carbon-silicon composite may not be efficiently pulverized, and thus an average particle diameter of the final carbon-silicon composite may be large.

Also, in this case, the pulverization may not be well performed, and thus materials that form the surface of the composite may break which may result in a large amount of fine powders, and this may increase a manufacturing cost and decrease an electrode efficiency.

In this regard, the mixture of the present invention may be pulverized after the primary carbonization process and then pulverized once more after the second carbonization process to prepare a carbon-silicon composite, and thus a shape of the carbon-silicon composite may be round and have a high uniformity.

Therefore, when a negative electrode is manufactured by controlling the carbon-silicon composite and graphite to be included at a particle size ratio that satisfies 1.0≦D_{G}/D_{Si—C}≦1.8, as described above, a high electrode density and an excellent electrolyte solution impregnating property may be realized.

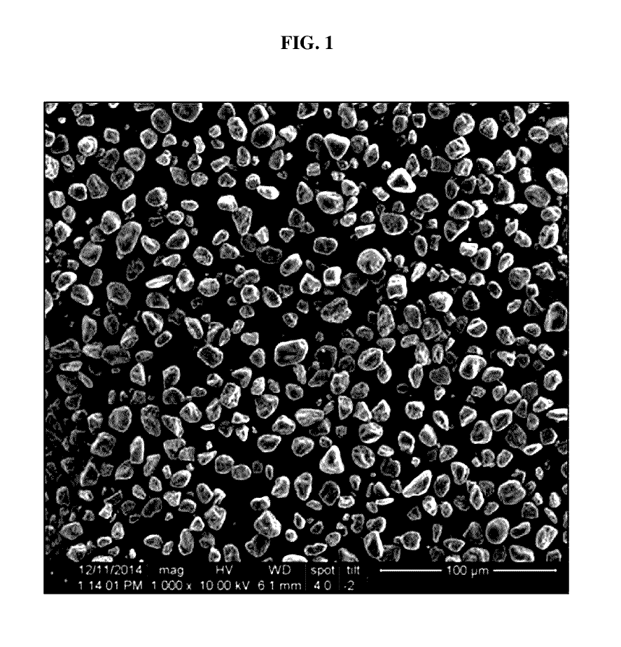

FIG. 1 is an scanning electron microscope (SEM) image of a carbon-silicon composite prepare in Example 1 according to the manufacturing method for the present invention, and it may be known that a shape of the carbon-silicon composite is round and has excellent uniformity.

According to the method for manufacturing the negative electrode for a secondary battery, a particle size of the carbon-silicon composite may satisfy 3 μm≦D_{Si—C}≦12 μm, and a particle size of the graphite may satisfy 8 μm≦D_{G}≦20 μm.

When the carbon-silicon composite and the graphite together form a composite at the particle size ratio described above and used in the negative electrode, excellent battery lifespan characteristics may be exhibited as a porosity is at an appropriate level and an electrolyte solution impregnating property is excellent, at the same time realizing an excellent charge/discharge capacity may be realized as an electrode density is at a level as high as that of the graphite.

As described above, a ratio of particle sizes of graphite and the carbon-silicon composite is related to a porosity, or, particularly, fine pores. When a particle size ratio of the carbon-silicon composite and graphite satisfy 1.0≦D_{G}/D_{Si—C}≦1.8, a porosity inside the electrode may be appropriately secured while realizing a high electrode density of the electrode, and thus the electrode may exhibit an excellent electrolyte solution impregnating property.

Also, the pulverizing of the primary carbonization process and the secondary carbonization process may be performed at a pressure of 13 bar or lower, or, particularly, the pulverizing of the primary carbonization process may be performed at a pressure of about 10 bar or higher.

When the pulverizing of the primary carbonization process is performed at a pressure lower than 10 bar, for example, about 3 bars to about 6 bars, an uniformity of an average particle diameter of the carbon-silicon composite decreases, and the average value itself increases, and thus a high density during a roll-pressing process may not be obtained, and thus when the carbon-silicon composite is used in the negative electrode, the battery characteristics may deteriorate.

Therefore, when the carbon-silicon composite and graphite prepared by using the method for manufacturing a negative electrode for a secondary battery according to the present invention as a negative electrode active material in the negative electrode for a secondary battery, the secondary battery may have a porosity of the most appropriate degree and a high electrode density.

In the step (d), the carbon-silicon composite and graphite are mixed to prepare a negative electrode active material, and, in some embodiments, the carbon-silicon composite and graphite in the negative electrode may be mixed at a weight ratio in a range of about 50:50 to about 1:99, or, preferably, about 30:70 to about 20:80.

When the carbon-silicon composite and graphite are mixed at the weight ratio within this range, a porosity of the negative electrode may be appropriate, and, at the same time, a high electrode density may be realized during a roll-pressing process.

In the step (e), a current collector is coated with the mixed resultant and a conducting agent, a binder, and a thickener, and the current collector may be dried and roll-pressed after the coating process to prepare a negative electrode for a secondary battery.

Examples of the conducting agent may include at least one selected from the group consisting of a carbonaceous material, a metal material, a metal oxide, and an electric conductive polymer. In some embodiments, the conducting agent may be carbon black, acetylene black, Ketjen black, furnace black, carbon fibers, fullerene, copper, nickel, aluminum, silver, a cobalt oxide, a titanium oxide, a polyphenylene derivative, polythiophene, polyacene, polyacetylene, polypyrrole, or polyaniline.

Examples of the binder may include various binder polymers such as styrene-butadiene rubber (SBR), carboxymethyl cellulose (CMC), a vinylidenefluoride-hexafluoropropylene copolymer (PVDF-co-HFP), polyvinylidenefluoride, polyacrylonitrile, and polymethylmethacrylate, and the thickener is used to control a viscosity, which may be carboxymethyl cellulose, hydroxymethyl cellulose, hydroxyethyl cellulose, or hydroxypropyl cellulose.

The current collector may be formed of stainless steel, nickel, copper, titanium, or an alloy thereof, and, preferably, copper or a copper alloy may be used among these.

The present invention may provide a lithium secondary battery including a negative electrode for a secondary battery that is prepared by using the method for manufacturing a negative electrode for a secondary battery according to the present invention.

When the negative electrode for a secondary battery according to the present invention is included, the lithium secondary battery may have an excellent charge/discharge capacity, cycle performance, and lifespan characteristics. The lithium secondary battery may include the negative electrode for a secondary battery; a positive electrode that includes a positive electrode active material; a separator; and an electrolyte solution.

A material for forming the positive electrode active material may be a compound capable of intercalating and deintercalating lithium such as LiMn₂O₄, LiCoO₂, LiNIO₂, or LiFeO₂.

The separator that insulates the electrodes between the negative electrode and the positive electrode may be an olefin-based porous film of polyethylene or polypropylene.

Also, examples of the electrolyte solution may be prepared by dissolving at least one electrolyte that is formed of a lithium salt such as LiPF₆, LiBF4, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ+1SO₂)(C_{y}F_{2y}+1SO₂) (where x and y are natural numbers), LiCl, or LiI in at least one aprotic solvent selected from propylene carbonate, ethylene carbonate, butylene carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethylsulfoxide, dioxane, 1,2-dimethoxyethane, sulfolane, dichloroethane, chlorobenzene, nitrobenzene, dimethyl carbonate, methylethyl carbonate, diethyl carbonate, methylpropyl carbonate, methylisopropyl carbonate, ethylpropyl carbonate, dipropyl carbonate, diisopropyl carbonate, dibutyl carbonate, diethylene glycol, and dimethyl ether.

In some embodiments, a plurality of lithium secondary batteries may be electrically connected, and thus a medium-to-large sized battery module or a battery pack may be provided. The medium-to-large sized battery module or the battery pack may be used as at least one medium-to-large sized device power source selected from a power tool; an electric automobile that may include an electric vehicle (EV), a hybrid electric vehicle (HEV), or a plug-in hybrid electric vehicle (PHEV); an electric truck, an electric common vehicle, or a system for electric power storage.

Thereinafter, one or more embodiments of the present invention will be described in detail with reference to the following examples. However, these examples are not intended to limit the scope of the one or more embodiments of the present invention.

### Comparison Between Physical Properties of Electrodes for Secondary Battery According to Particle Size Ratio of Carbon-Silicon Composite and Graphite

### Example 1

A polyacrylic acid-polystyrene block copolymer was synthesized using polyacrylic acid and polystyrene by a reversible addition-fragmentation chain transfer method. Here, a number average molecular weight (Mₙ) of polyacrylic acid was 4090 g/mol, and a number average molecular weight (Mₙ) of polystyrene was 29370 g/mol. 0.1 g of the polyacrylic acid-polystyrene block copolymer was mixed with 8.9 g of N-methyl-2-pyrrolidone (NMP), a dispersion medium to prepare a solution mixture. 1 g of Si particle having an average particle diameter of 50 nm was added to 9 g of the solution mixture. The solution including the Si particle was treated with ultrasound waves of 20 kHz for 10 minutes by using a sonic horn and rested for 20 minutes to prepare a mixture including Si-block copolymer core-shell particles.

Amorphous carbon evaporated at 350° C. was mixed with the mixture and stirred for about 30 minutes to prepare a mixture including the amorphous carbon in NMP, a dispersion medium. Here, coal tar pitch and the Si-block copolymer core-shell particles are mixed at a weight ratio of 97.5:2.5. In vacuum, NMP, the dispersion medium, was evaporated at a temperature in a range of about 110° C. to about 120° C.

The mixture, from which the dispersion medium was evaporate, was primarily carbonized at a temperature of 470° C. by increasing the temperature at a rate of 10° C./min in an inert atmosphere for 6 hours at a pressure of 7 bar, and the resultant was pulverized at a pressure of 10 bar by using a Jet-mill.

The pulverized resultant was secondarily carbonized at a temperature of 1100° C. by increasing the temperature at a rate of 10° C./min in an inert atmosphere for 1 hour at a pressure of 7 bar, and the resultant was pulverized at a pressure of 4 bar by using a Jet-mill, and thus a carbon-silicon composite was obtained.

After undergoing a classification process, only the carbon-silicon composite having D50 of 10 μm was selected, and spherical graphite having D50 of 12 μm was used to mix the carbon-silicon composite and the graphite at a ratio of 75:25, thereby manufacturing a negative electrode active material.

### Example 2

A negative electrode active material was prepared in the same manner as in Example 1, except that D50 of the spherical graphite was 14 μm.

### Example 3

A negative electrode active material was prepared in the same manner as in Example 1, except that D50 of the spherical graphite was 16 μm.

### Example 4

A negative electrode active material was prepared in the same manner as in Example 1, except that D50 of the spherical graphite was 18 μm.

### Example 5

A negative electrode active material was prepared in the same manner as in Example 1, except that D50 of the carbon-silicon composite that was manufactured according to Example 1 and selected after undergoing the classification process was 8 μm, and D50 of the spherical graphite was 10 μm.

### Example 6

A negative electrode active material was prepared in the same manner as in Example 1, except that D50 of the carbon-silicon composite that was manufactured according to Example 1 and selected after undergoing the classification process was 8 μm, and D50 of the spherical graphite was 12 μm.

### Example 7

A negative electrode active material was prepared in the same manner as in Example 1, except that D50 of the carbon-silicon composite that was manufactured according to Example 1 and selected after undergoing the classification process was 6 μm, and D50 of the spherical graphite was 8 μm.

### Comparative Example 1

A negative electrode active material was prepared by using only the carbon-silicon composite having D50 of 10 μm which was manufactured according to Example 1 and selected after undergoing the classification process.

### Comparative Example 2

A negative electrode active material was prepared by using only the spherical graphite having D50 of 12 μm.

### Comparative Example 3

A negative electrode active material was prepared in the same manner as in Example 1, except that D50 of the carbon-silicon composite that was manufactured according to Example 1 and selected after undergoing the classification process was 3 μm, and D50 of the spherical graphite was 12 μm.

### Comparative Example 4

A negative electrode active material was prepared in the same manner as in Example 1, except that D50 of the carbon-silicon composite that was manufactured according to Example 1 and selected after undergoing the classification process was 5 μm, and D50 of the spherical graphite was 12 μm.

### Comparative Example 5

A negative electrode active material was prepared in the same manner as in Example 1, except that D50 of the carbon-silicon composite that was manufactured according to Example 1 and selected after undergoing the classification process was 8 μm, and D50 of the spherical graphite was 16 μm.

### Comparative Example 6

A negative electrode active material was prepared in the same manner as in Example 1, except that D50 of the carbon-silicon composite that was manufactured according to Example 1 and selected after undergoing the classification process was 8 μm, and D50 of the spherical graphite was 5 μm.

1) Tap Density Measurement of Negative Electrode Active Material

Tap densities of the negative electrode active materials for a secondary battery prepared in Examples and Comparative Examples were measured by tapping at least 4000 times for 2 hours by using the Auto Tap Analyzer (available from Quantachrome).

2) Measurement of Electrode Density, Electrode Porosity, and Fine Porosity

Each of the negative electrode active materials prepared in Examples and Comparative, carbon black, carboxylmethyl cellulose (CMC), and styrenebutadiene (SBR) were mixed in water at a weight ratio of 85:5:3:7 to prepare a composition for negative electrode slurry.

The composition was coated on a copper current collector, dried for 1 hour in an oven at 110° C., and roll-pressed to prepare a negative electrode for a secondary battery, and an electrode density and an electrode porosity of the negative electrode were measured.

The electrode density was obtained by dividing a weight of the electrode coated on the Cu foil with a volume (an electrode thickness×area).

The electrode porosity was obtained by using the tap density and the electrode density using Equation (1) below:

$$Electrode porosity = \frac{{D}_{R} - {D}_{T}}{1 + {D}_{R} - {D}_{T}} \\ ( {D}_{R} \text{:} electrode density , {D}_{T} \text{:} tap density ) . \qquad Equation ( 1 )$$

The fine porosity was measured by using a mercury adsorption method.

The results of particle distribution and the ratios of the negative electrode active material prepared in Examples and Comparative Examples and tap densities, electrode densities, electrode porosities, and fine porosities of the negative electrode active materials are shown in Table 1 (a particle distribution ratio was rounded off at the 3^{rd} decimal place).

TABLE 1

| | | | | | Electrode | Electrode | |
|---|---|---|---|---|---|---|---|
| | D_{Si—C} | D_{G} | | Tap density | density | porosity | Ratio of fine pores |
| | (μm) | (μm) | D_{G}/D_{Si—C} | (g/cc) | (g/cc) | (%) | (%) |
| Example 1 | 10 | 12 | 1.2 | 1.172 | 1.74 | 36.2 | 38.3 |
| Example 2 | 10 | 14 | 1.4 | 1.164 | 1.70 | 34.9 | 41.6 |
| Example 3 | 10 | 16 | 1.6 | 1.152 | 1.59 | 30.5 | 45.1 |
| Example 4 | 10 | 18 | 1.8 | 1.138 | 1.52 | 27.6 | 47.4 |
| Example 5 | 8 | 10 | 1.25 | 1.125 | 1.73 | 37.7 | 36.2 |
| Example 6 | 8 | 12 | 1.5 | 1.120 | 1.66 | 35.1 | 43.8 |
| Example 7 | 6 | 8 | 1.33 | 1.092 | 1.54 | 30.9 | 40.4 |
| Comparative | 10 | — | — | 1.197 | 1.40 | 16.9 | 14.2 |
| Example 1 | | | | | | | |
| Comparative | — | 12 | — | 1.135 | 1.97 | 45.5 | 26.7 |
| Example 2 | | | | | | | |
| Comparative | 3 | 12 | 4 | 1.022 | 1.31 | 22.4 | 76.5 |
| Example 3 | | | | | | | |
| Comparative | 5 | 12 | 2.4 | 1.070 | 1.36 | 22.5 | 61.2 |
| Example 4 | | | | | | | |
| Comparative | 8 | 16 | 2.0 | 1.116 | 1.41 | 22.7 | 55.9 |
| Example 5 | | | | | | | |
| Comparative | 8 | 5 | 0.63 | 1.131 | 1.39 | 20.6 | 31.2 |
| Example 6 | | | | | | | |

The negative electrode of Comparative Example 1 includes only the carbon-silicon composite as a negative electrode active material, and since only the carbon-silicon composite having the same particle size is included, the fine porosity is low, and the negative electrode is hard due to the composite characteristics. Thus, the roll-pressing may be insufficiently performed on the electrode during the roll-pressing process, and thus it may be known that the electrode density of the electrode is very low.

Also, the negative electrode of Comparative Example 2 including the only spherical graphite as a negative electrode active material may be easily roll-pressed due to characteristics of the graphite having porous spaces, and thus the electrode density of the electrode is very high, but an electrolyte solution impregnating property may be poor. The electrode porosity is high in the data of Comparative Example 2 because a ratio of pores inside the electrode is high since the spherical graphite particle itself is porous, and the ratio of fine pores is lower than 30% despite the high electrode porosity, which indicates that a ratio of pores outside the particle, i.e., between the particles, is very low.

Also, the negative electrodes of Comparative Examples 3 and 4 have significantly small carbon-silicon composite compared to the particle size of the spherical graphite, where the electrode densities and fine porosities of the negative electrodes of Comparative Examples 3 and 4 are very high.

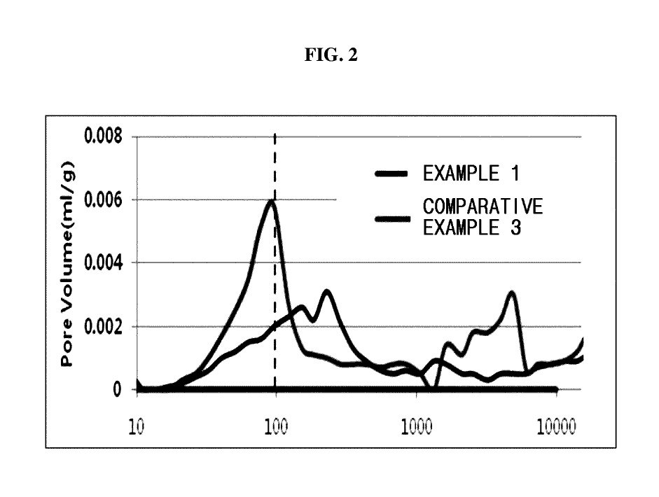

FIG. 2 shows a graph that illustrates distribution of pores of the negative electrodes prepared in Example 1 and Comparative Example 3 of the present invention.

D_{G}/D_{Si—C} of the negative electrode of Example 1 is 1.2, and D_{G}/D_{Si—C} of the negative electrode of Comparative Example 3 is 4. Thus, as shown in the graph, the ratio of fine pores of the negative electrode of Example 1 having a particle diameter of 100 nm or lower is low, and the ratio of fine pores of the negative electrode of Comparative Example 3 is very high.

This is because the carbon-silicon composite is inserted between empty spaces within the graphite, which increases the fine porosity compared to the whole pores, due to a large size difference between the graphite and the carbon-silicon composite. Also, the carbon-silicon composite may have less number of internal pores, which makes the composite relatively hard and angulated compared to graphite, and thus the carbon-silicon composite may not be compressed as graphite does during a roll-pressing process, and additional fine pores may be formed between within graphite, which becomes a cause of failure to meet the electrode density standard, 1.5 g/cc.

Therefore, in the cases of the negative electrodes of Comparative Examples 3 and 4, the carbon-silicon composite is inserted to the spaces within graphite, and thus the fine porosities may increase, which may result a decrease in electrode densities even when the electrode porosities are maintained at an appropriate level. Therefore, it was confirmed that a battery capacity may be too low.

On the other hand, in the cases of the electrodes for a secondary battery prepared in Examples 1 to 7 which has a particle size ratio of the carbon-silicon composite and graphite that satisfy 1.0≦D_{G}/D_{Si—C}≦1.8, the electrode porosities and the fine porosities are all realized at appropriate levels, and, at the same time, have relatively high electrode densities, and thus it may be confirmed that lifespan characteristics and energy density of the battery may be excellent as well.

3) Measurement of Electrode Density and Shape of Cross-Sectional View of Negative Electrode According to Roll-Pressing

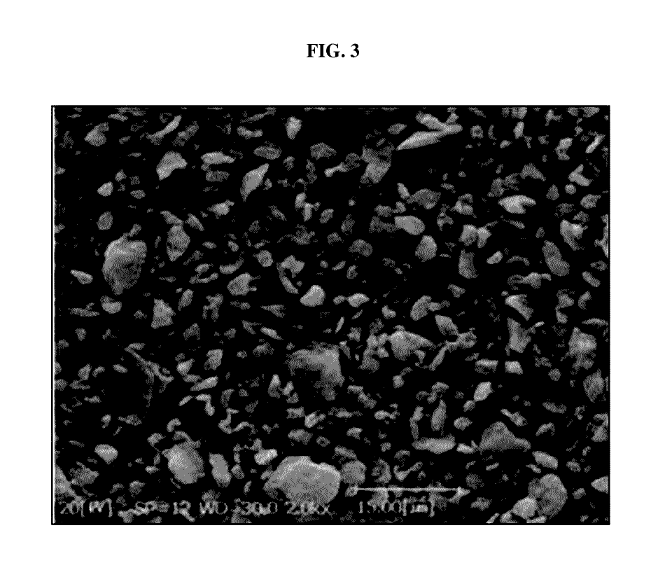

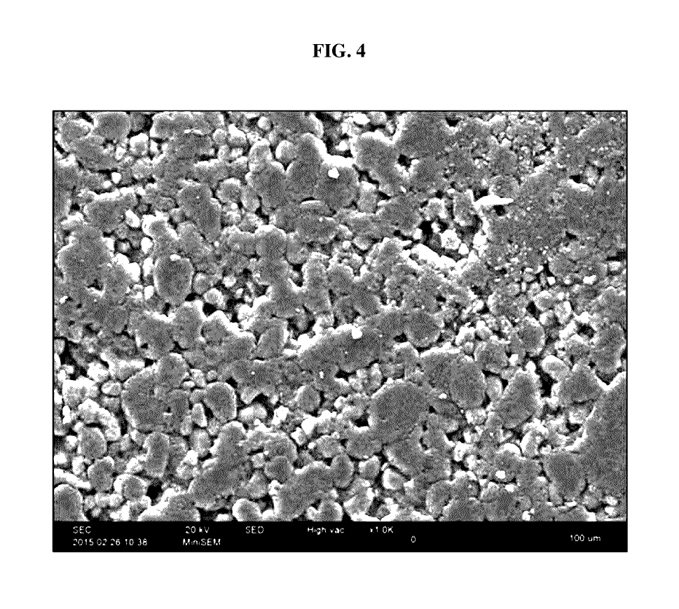

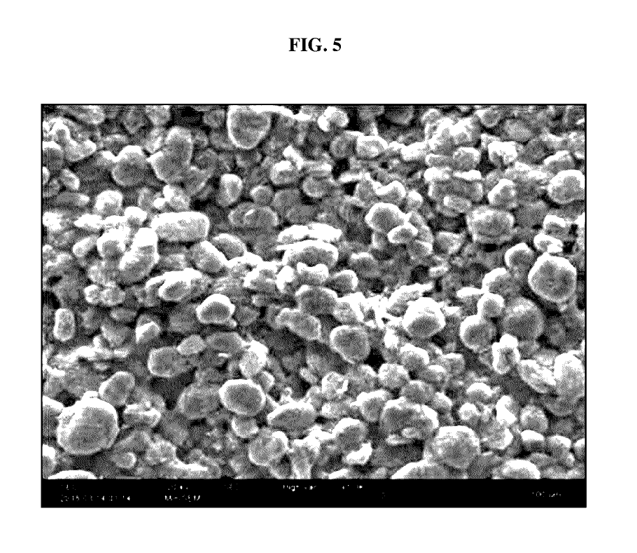

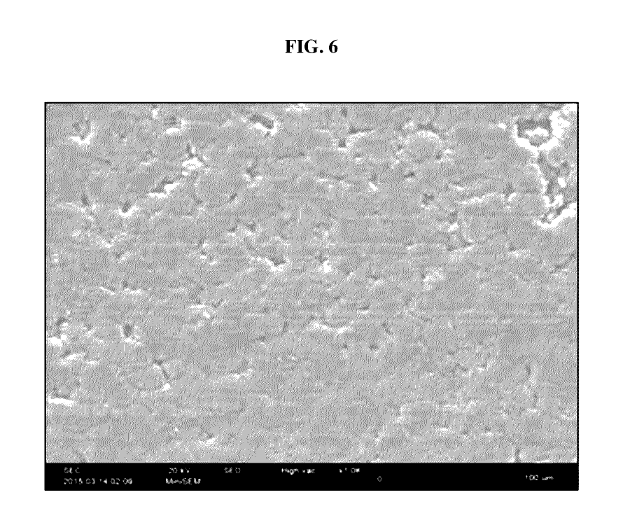

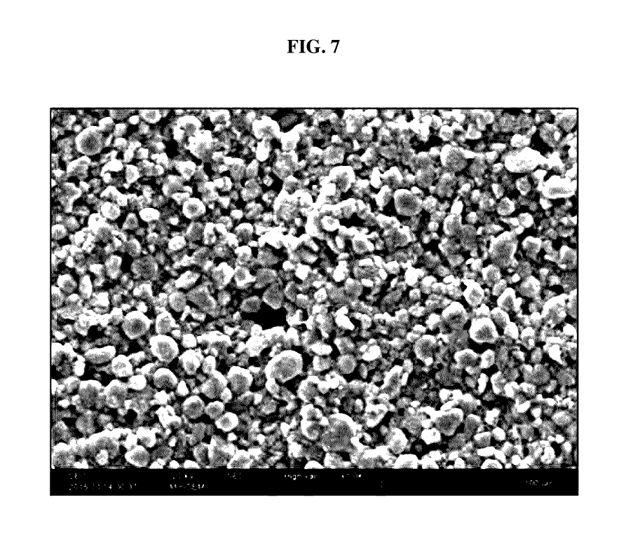

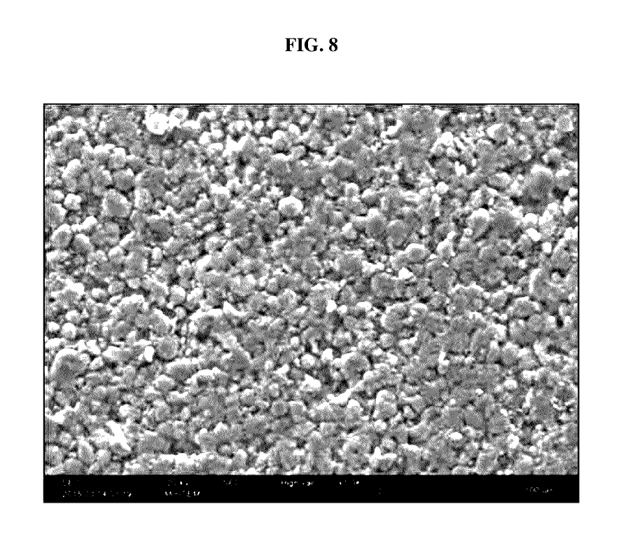

Electrode densities of the negative electrodes prepared in Example 1 and Comparative Examples 1 and 2 were measure, and the results are shown in Table 2. Shapes of cross-sectional views of the negative electrodes prepared in Example 1 and Comparative Examples 1 and 2 are shown in FIGS. 3 to 8. The roll-pressing was performed by passing the electrode between two rolls having a diameter of 140 mm, and a process rate of the rolls during the roll-pressing was 2 RPM, and a distance between the rolls was 40 mm.

TABLE 2

| | Not | |
|---|---|---|
| | roll-pressed | Roll-pressed |
| Electrode density of Example 1 (g/cc) | 0.92 | 1.74 |
| Electrode density of Comparative Example 1 | 0.96 | 1.26 |
| (g/cc) | | |
| Electrode density of Comparative Example 2 | 0.93 | 1.97 |
| (g/cc) | | |

In the case of the negative electrode of Comparative Example 1 that only includes the carbon-silicon composite, a hardness of the particle itself is high even after the roll-pressing, and thus the electrode density does not increase significantly, which may result in poor charge/discharge characteristics.

Also, when the same pressure was applied, the electrode density of the negative electrode of Comparative Example 2 that only includes graphite is the highest, but the number of pores outside the particles is too small, and thus impregnation of the electrolyte solution is not preferable, which may thus increase resistance of the electrode. Therefore, battery lifespan characteristics may deteriorate.

On the other hand, in the case of the negative electrode of Example 1, it was confirmed that the pores outside the particle was secured to the level of that of the carbon-silicon composite, at the same time, increasing the electrode density to 1.74 g/cc, which is an electrode density of graphite. Thus, when the negative electrode of Example 1 is used as a negative electrode active material, a secondary battery having improved battery characteristics and lifespan characteristics may be manufactured.

4) Measurement of Electrolyte Solution Impregnation Time

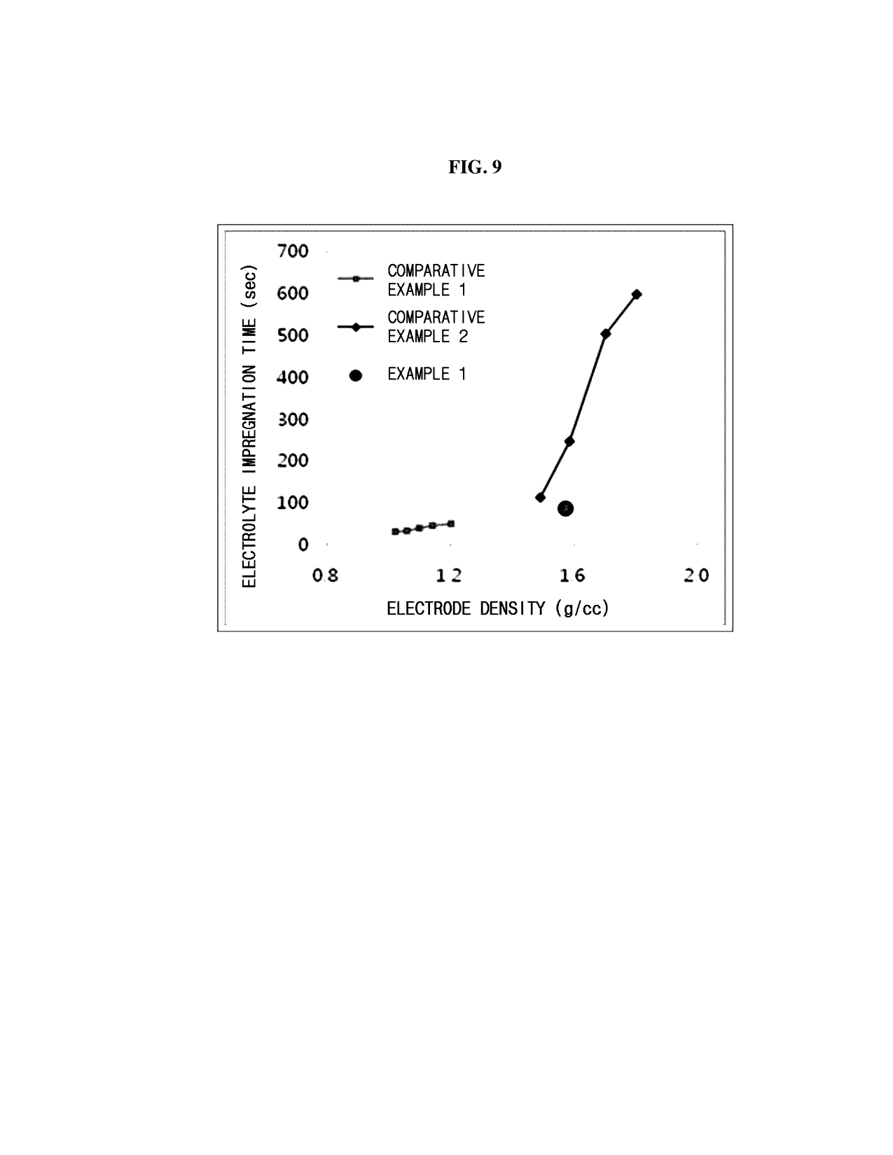

Electrolyte solution impregnation times and electrode densities of the negative electrodes prepared in Example 1 and Comparative Examples 1 and 2 are shown in the graph of FIG. 9. The electrolyte solution impregnation time was measured as follows.

The roll-pressed electrode was punched to a circular-shape having a diameter of 16 mm by using a punching device. The electrode having a circular shape was placed in a glove box, and one drop of an electrolyte solution was dropped thereon by using a pipette, where an amount of the electrolyte solution was 10 ul. The electrolyte solution dropped thereon was not absorbed right away but slowly absorbed into the electrode as time goes by. The elapsed time was measured from a point when the electrolyte solution was dropped to a point when no electrolyte solution was observed on a surface of the electrode as the electrolyte solution was completely absorbed.

As shown in FIG. 9, the electrode of Comparative Example 1 having a low electrode density had the very short impregnation time, and this was because pores between the particles were secured.

On the other hand, the electrode of Comparative Example 2 having a high electrode density was compressed a lot due to the soft physical property of graphite, and thus there was almost no pore between the particles, and thus the elapsed time for impregnation is long.

In the case of the electrode of Example 1, it was confirmed that the electrolyte solution impregnation time was not significantly increased even at a high electrode density, and thus enhanced lifespan characteristics may be secured by excellent charge/discharge capacity and improvement of a lithium ion impregnating property.

As described above, according to one or more embodiments of the present invention, a negative electrode for a secondary battery includes a carbon-silicon composite and graphite, wherein the carbon-silicon composite includes evenly distributed Si-block copolymer core-shell particles, and thus the negative electrode may have appropriate levels of an electrode porosity and a fine porosity, which may thus allow the electrode to exhibit excellent electrolyte solution impregnating property and a high electrode density at a lever of that of the graphite.

Also, a secondary battery including the negative electrode for a secondary battery according to the present invention may further improve a charge capacity, lifespan characteristics, and suitability with a conventional negative electrode material.

What is claimed is:

1. A negative electrode for a secondary battery, the negative electrode comprising a negative electrode active material that comprises:
a carbon-silicon composite having a Si-block copolymer core-shell particle in a carbonaceous material; and
graphite,
wherein the negative electrode comprises a plurality of pores therein, and
when a 50% accumulated weight particle size distribution diameter in particle distribution in the negative electrode is D50, D50 of the carbon-silicon composite is D_{Si—C}, and D50 of graphite is D_{G}, D_{Si—C} and D_{G} satisfy 1.0≦D_{G}/D_{Si—C}≦1.8.

2. The negative electrode of claim 1, wherein D_{Si—C} satisfies 3 μm≦D_{Si—C}≦12 μm.

3. The negative electrode of claim 1, wherein D_{G} satisfies 8 μm≦D_{G}≦20 μm.

4. The negative electrode of claim 1, wherein an electrode porosity of the negative electrode is in a range of about 25% to about 45%.

5. The negative electrode of claim 1, wherein when pores having a particle diameter less than 100 nm among the pores are referred to as fine pores, a porosity of the fine pores is in a range of about 30% to about 50%.

6. The negative electrode of claim 1, wherein a tap density (D_{T}) of the negative electrode active material is in a range of about 1.0 g/cc to about 1.2 g/cc.

7. The negative electrode of claim 1, wherein an electrode density (D_{R}) of the negative electrode is in a range of about 1.35 g/cc to about 1.85 g/cc.

8. The negative electrode of claim 1, wherein a weight ratio of the carbon-silicon composite and the graphite in the negative electrode is in a range of about 50:50 to about 1:99.

9. The negative electrode of claim 1, wherein the carbon-silicon composite and the graphite have a spherical shape.

10. A method for manufacturing a negative electrode for a secondary battery, the method comprising:
(a) mixing a slurry solution including Si-block copolymer core-shall particles and a carbonaceous raw material to prepare a mixture;
(b) performing heat-treatment on the mixture;
(c) carbonizing and pulverizing the heat-treated mixture to prepare a carbon-silicon composite;
(d) mixing the carbon-silicon composite and graphite to prepare a negative electrode active material; and
(e) coating a current collector with a mixture of the negative electrode active material, a conducting agent, a binder, and a thickener,
wherein the (c) carbonizing and pulverizing are repeated at least twice, and
when a 50% accumulated weight particle size distribution diameter in particle distribution in the negative electrode is D50, D50 of the carbon-silicon composite is D_{Si—C}, and D50 of graphite is D_{G}, D_{Si—C} and D_{G} satisfy 1.0≦D_{G}/D_{Si—C}≦1.8.

11. The method for claim 10, wherein D_{Si—C} satisfies 3 μm≦D_{Si—C}≦12 μm.

12. The method for claim 10, wherein D_{G} satisfies 8 μm≦D_{G}≦20 μm.

13. The method for claim 10, wherein (b) the performing heat-treatment on the mixture is performed at a temperature in a range of about 100° C. to about 200° C.

14. The method for claim 10, wherein (c) the mixing the carbon-silicon composite and graphite is repeated at least twice at temperatures different from each other.

15. The method for claim 14, wherein (c) the mixing the carbon-silicon composite and graphite comprises a primary carbonization process which comprises heat-treating the mixture at a temperature in a range of about 400° C. to about 600° C. for about 1 hour to about 24 hours and then pulverizing the mixture; and a secondary carbonization process which comprises heat-treating the resultant of the primary carbonization process at a temperature in a range of about 700° C. to about 1400° C. for about 1 hour to about 24 hours and then pulverizing the resultant.

16. The method for claim 15, wherein the pulverizing of the primary carbonization process or the secondary carbonization process is performed at a pressure of 13 bar or lower.

17. The method for claim 10, wherein a weight ratio of the carbon-silicon composite and graphite in (d) the mixing the carbon-silicon composite and graphite is in a range of about 50:50 to about 1:99.
